(19) United States
(12) Patent Application Publication
(10) Pub. No.: US 2008/0063828 A1
(43) Pub. Date: Mar. 13, 2008

(54) OPTICAL DISC

(76) Inventors: Chen Peng, Taipei City (TW); Fung-Hsu Wu, Gueishan Township (TW); Jia-Ray Liu, Taoyuan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/757,509

(22) Filed: Jun. 4, 2007

(30) Foreign Application Priority Data
Sep. 8, 2006 (TW) 095133367

(51) Int. Cl. B32B 27/00

(52) U.S. Cl. 428/64.4

(57) ABSTRACT

The invention provides an optical disc with its substrate formed of a biodegradable material mixed with a plurality of microcapsules encapsulating an additive and/or mixed with the additive. Therefore, the substrate of the optical disc, according to the invention, is biodegradable, with a long life expectancy as desired.

### BACKGROUND OF THE INVENTION

1. Field of the invention

The present invention relates to an optical disc, and more particularly, to an optical disc which is biodegradable with a sufficient length of life guaranteed for use.

2. Description of the prior art

With the development of electronic and digital devices, more and more data, such as documents, photos, music, and movies, are now recorded and stored in digital form. Moreover, most of the digital data is backed-up in optical storage media, such as CD-R, DVD−R, and DVD+R.

In recent years, the advantages of high maturity, low cost, and increased capacity in optical discs and related recording devices have made optical discs be widely used to store and backup the digital data. Most of the substrate used in optical discs nowadays is made of polycarbonate (PC) because of its advantages, such as high transparency, good shock resistance, and good heat-resistance. However, the good stability of PC has also made the substrate uneasy to be naturally decomposed, and would cause serious environment problems. To resolve the problems caused by PC as described above, many systems and methods for the recovering of the PC substrate on discarded optical discs are developed. However, most of the systems and methods have complicated processes and cannot guarantee 100% recovery. Furthermore, some of the systems and methods may cause environment pollution during the recovery process.

Additionally, substrate formed of biodegradable material is used to replace the traditional PC substrate of optical storing media, so as to resolve the problem of environment pollution caused by PC substrate. The related technologies on biodegradable substrate could refer to JP Patent Publication No. 2006018992, JP Patent Publication No. 2006031914, and the U.S. Patent Application No. 20060083151. Although the biodegradable substrate solves the environment pollution problem caused by the PC substrate, the preservation term of the optical disc formed with biodegradable substrate would be shortened, which impairs the original idea for preservating data in a long term.

### SUMMARY OF THE INVENTION

Accordingly, one aspect of the present invention is to provide an optical disc. Moreover, the optical disc of the invention has a biodegradable substrate with sufficient life for use, so as to overcome the problems described above.

In one preferred embodiment of the present invention, the optical disc includes a substrate, a reflective layer, a recording layer, and a cover layer. The substrate is formed of a biodegradable material mixed with a plurality of microcapsules which comprise an additive, and/or mixed with the additive. The additive includes at least one anti-oxidant, and/or at least one antiseptic, and/or at least one antibiotic. Moreover, the reflective layer is formed over the substrate; the recording layer is formed over the reflective layer; and the cover layer is formed over the recording layer.

In another preferred embodiment of the present invention, the optical disc includes a substrate, a reflective layer, a recording layer, a cover layer, and a coating layer. The substrate is formed of a biodegradable material, the reflective layer is formed over a first surface of the substrate, the recording layer is formed over the reflective layer, the cover layer is formed over the recording layer, the coating layer is formed on a second surface of the substrate, and the coating layer includes a plurality of microcapsules which contains an additive and/or mixed with the additive. Moreover, the additive includes at least one anti-oxidant, and/or at least one antiseptic, and/or at least one antibiotic.

The substrate of the optical disc of the invention is biodegradable and can be produced without adjusting the manufacturing process and increasing the manufacturing cost largely.

The advantage and spirit of the invention may be understood by the following recitations together with the appended drawings.

### BRIEF DESCRIPTION OF THE APPENDED DRAWINGS

FIG. 1 is a sectional view of an optical disc according to the first preferred embodiment of the present invention.

FIG. 2 is a sectional view of an optical disc according to an embodiment of the present invention.

FIG. 3 is a sectional view of an optical disc according to the second preferred embodiment of the present invention.

### DETAILED DESCRIPTION OF THE INVENTION

The present invention provides an optical disc, and more particularly, the substrate used on the optical disc is biodegradable with a sufficient length of life guaranteed for use. The preferred embodiments are disclosed as below.

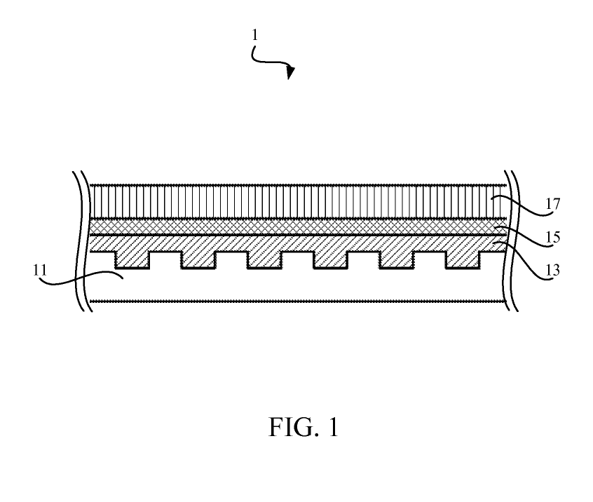

Please refer to FIG. 1, which shows a sectional view of an optical disc according to the first preferred embodiment of the present invention. As shown in FIG. 1, the optical disc 1 includes a substrate 11, a reflective layer 13, a recording layer 15, and a cover layer 17.

The substrate 11 is formed of a biodegradable material mixed with an additive. The reflective layer 13 is formed over the substrate 11; the recording layer 15 is formed over the reflective layer 13; and the cover layer 17 is formed over the recording layer 15.

In an embodiment, the biodegradable material can be Polylactic Acid (PLA), starch, Polycaprolactone (PCL), Poly Vinyl Alcohol (PVA), Dihydroxy Acid Dibastic Alcohol, Aromatic Hydrocarbon Copolyester, Poly-3-Hydroxybutyrate-co-3-Polyhydroxyvalerate (PHBV), or other suitable materials. However, the transparency of the substrate formed by biodegradable material is lower. Therefore, the structure of the optical disc 1 based on the first preferred embodiment of the invention is more suitable for the specification that does not require a transparent substrate, such as dummy discs complied with a Blu-ray disc (BD) specification, a DVD+R specification, a DVD−R specification, a DVD+RW specification, a DVD−RW specification, and a High Density DVD (HD-DVD) specification. For example, the optical disc of the invention can be a dummy disc complied with the HD-DVD specification.

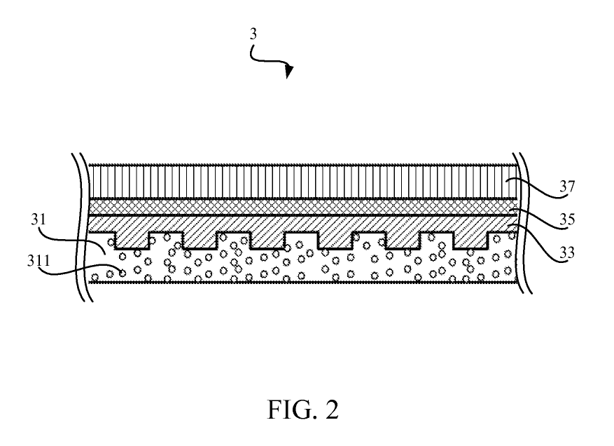

Please refer to FIG. 2, which shows a sectional view of an optical disc according to an embodiment of the present invention, with the mixture of the additive and the biodegradable material. In the embodiment, the optical disc 3 includes the substrate 31, the reflective layer 33, the recording layer 35, and the cover layer 37. Particularly, the substrate 31 is formed of the biodegradable material with a plurality of microcapsules 311. Each of the microcapsules 311 contains an additive. Furthermore, the additive includes at least one anti-oxidant, and/or at least one antiseptic, and/or at least one antibiotic.

In another embodiment, the substrate 31 is formed of the biodegradable material with the additive as described above. However, in another embodiment, the substrate 31 is formed of the biodegradable material with the microcapsules 311 and the additive as described above.

In practice, the additive can include at least one anti-oxidant, and/or at least one antiseptic, and/or at least one antibiotic. The anti-oxidants under the category of additives can be, sodium metabisulfite, sodium thiosulfate, acetyl cystine, Butylated Hydroxy Anisole (BHA), Butyl Hydroxy Toluene, Tertiary-Butylhydroxyquinone (TBHQ), Dibutyl Hydroxy-Toluene (BHT), Butyl Hydroxy Anisole (BHA), L-Ascorbic Acid, Sodium L-Ascorbate, L-Ascorbyl Stearate, L-Ascorbyl Palmitate, Erythorbic Acid, Sodium Erythorbate, dl-α-Tocopherol, Propyl Gallate, Guaiac Resin, L-Cysteine Monohydro-chloride, Tertiary-Butyl Hydro-quinone, Calcium L-Ascorbate, Tocopherols Concentrate Mixed, d-α-Tocopherol Concentrate, EDTA Na₂ or EDTA CaNa₂, Potassium Sulfite, Sodium Sulfite, Sodium Sulfite (Anhydrous), Sodium Bisulfite, Sodium Hydrosulfite, Potassium Metabisulfite, Potassium Bisulfite, Sodium Metabisulfite, et al. Furthermore, the antiseptics under the category of additives can include Benzalkonium chloride, Butylene chlorohydrin, Thimerosal, Phenylmercuric acetate, Phenylmercuric nitrate, Sorbic acid, Potassium Sorbate, Sodium Sorbate, Calcium Propionate, Sodium Propionate, Dehydroacetic Acid, Benzoic Acid, Sodium Benzoate, Ethyl p-Hydroxy-benzoate, Propyl p-Hydroxy-benzoate, Butyl p-Hydroxy-benzoate, Isopropyl p-Hydroxybenzoate, Isobutyl p-Hydroxy-benzoate, Biphenyl, Sodium Iacetate, Calcium Sorbate, Potassium Benzoate, Nisin, Thiamine Dilauryl-sulfate, Propionic Acid, Natamycin, et al. Moreover, the antibiotics under the category of the additives can include Oxazolidone, iso-Oxazoline, Chitin, Nitric oxide, Aminoglycoside, et al.

It should be noted that the usage and the amount of the anti-oxidant, antiseptic, and antibiotic as described above can be optionally adjusted to fit the requirement, such as the additive release frequency of the microcapsules, to postpone the beginning of biodegradation of the optical disc to meet the general guaranteed time of usage for optical discs, such as around 15 to 20 years.

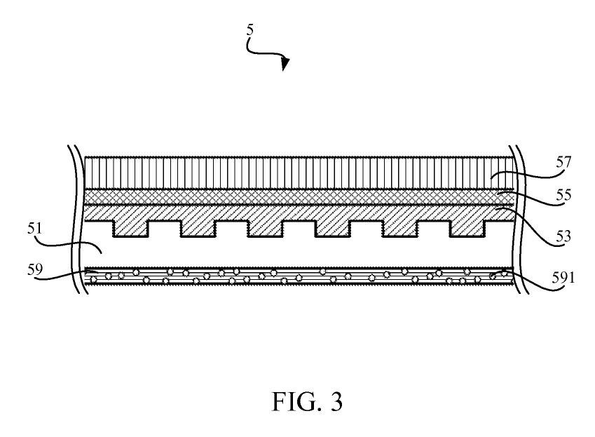

Please refer to FIG. 3, which shows a sectional view of an optical disc according to the second preferred embodiment of the present invention. As shown in FIG. 3, the optical disc 5 includes a substrate 51, a reflective layer 53, a recording layer 55, a cover layer 57, and a coating layer 59. The substrate 51 is formed of a biodegradable material. In practice, the types of biodegradable material are the same as described above.

As shown in FIG. 3, the reflective layer 53 is formed over a first surface of the substrate 51; the recording layer 55 is formed over the reflective layer 53; the cover layer 57 is formed over the recording layer 55; and the coating layer 59 is formed over a second surface of the substrate 51.

In an embodiment, the coating layer 59 includes a plurality of microcapsules 591. As shown in FIG. 3, each of the plurality of microcapsules 591 includes the additive as described above. In another embodiment, the coating layer 59 is formed by mixing the additive as described above. In further another embodiment, the coating layer 59 is formed by mixing the additive and the microcapsules as described above.

Similarly, the structure of the optical disc 5 based on the second preferred embodiment of the invention is more suitable for the specification that does not require a transparent substrate, such as the dummy discs complied with the BD specification, the DVD+R specification, the DVD−R specification, the DVD+RW specification, the DVD−RW specification, and the HD-DVD specification.

Similarly, the usage and amount of the anti-oxidant, antiseptic, and antibiotic as described above can be optionally adjusted to fit the requirement, such as the additive release frequency of the microcapsules, to postpone the beginning of biodegradation of the optical disc to meet the general guaranteed time of usage for optical discs, such as around 15 to 20 years.

Because the substrate of the optical disc of the invention is formed of biodegradable material, it can be degraded by microbes, and further reduces the hazardous impact on the environment. Furthermore, the optical disc of the invention includes additives, such as anti-oxidant, antiseptic, and antibiotic, to reduce the biodegradation effect. Furthermore, the biodegradation of the optical disc can be postponed to the desired expiration date thereof by adjusting the types and the amounts of the additive and the release frequency of the microcapsules.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical disc, comprising:
a substrate, formed of a biodegradable material mixed with a plurality of microcapsules comprising an additive and/or mixing with an additive;
a reflective layer, formed over the substrate;
a recording layer, formed over the reflective layer; and
a cover layer, formed over the recording layer.

2. The optical disc of claim 1, wherein the structure of the optical disc is configured to comply with one selected from the group consisting of: a Blu-ray disc (BD) specification, a DVD+R specification, a DVD−R specification, a DVD+RW specification, a DVD−RW specification, and a High Density DVD (HD-DVD) specification.

3. The optical disc of claim 2, wherein the biodegradation material is one selected from the group consisting of: Polylactic acid (PLA), starch, Polycaprolactone (PCL), Poly vinyl alcohol (PVA), Dihydroxy acid dibastic alcohol, Aromatic hydrocarbon copolyester, and poly-3-hydroxybutyrate-co-3-polyhydroxyvalerate (PHBV).

4. The optical disc of claim 3, wherein the additive comprises one selected from the group consisting of at least one anti-oxidant, one antiseptic, and one antibiotic.

5. The optical disc of claim 4, wherein the at least one anti-oxidant comprises one selected from the group consisting of: sodium metabisulfite, sodium thiosulfate, Acetyl cystine, Butylated Hydroxy Anisole (BHA), Butyl Hydroxy Toluene, Tertiary-Butylhydroxyquinone (TBHQ), Dibutyl Hydroxy-Toluene (BHT), Butyl Hydroxy Anisole (BHA), L-Ascorbic Acid, Sodium L-Ascorbate, L-Ascorbyl Stearate, L-Ascorbyl Palmitate, Erythorbic Acid, Sodium Erythorbate, dl-α-Tocopherol, Propyl Gallate, Guaiac Resin, L-Cysteine Monohydro-chloride, Tertiary-Butyl Hydro-quinone, Calcium L-Ascorbate, Tocopherols Concentrate Mixed, d-α-Tocopherol Concentrate, EDTA Na₂ or EDTA CaNa₂, Potassium Sulfite, Sodium Sulfite, Sodium Sulfite (Anhydrous), Sodium Bisulfite, Sodium Hydrosulfite, Potassium Metabisulfite, Potassium Bisulfite, and Sodium Metabisulfite.

6. The optical disc of claim 4, wherein the at least one antiseptic comprises one selected from the group consisting of: Benzalkonium chloride, Butylene chlorohydrin, Thimerosal, Phenylmercuric acetate, Phenylmercuric nitrate, Sorbic acid, Potassium Sorbate, Sodium Sorbate, Calcium Propionate, Sodium Propionate, Dehydroacetic Acid, Benzoic Acid, Sodium Benzoate, Ethyl p-Hydroxy-benzoate, Propyl p-Hydroxy-benzoate, Butyl p-Hydroxy-benzoate, Isopropyl p-Hydroxybenzoate, Isobutyl p-Hydroxy-benzoate, Biphenyl, Sodium iacetate, Calcium Sorbate, Potassium Benzoate, Nisin, Thiamine Dilauryl-sulfate, Propionic Acid and Natamycin.

7. The optical disc of claim 4, wherein the at least one antibiotic comprises one selected from the group consisting of: Oxazolidone, iso-Oxazoline, Chitin, Nitric oxide, and Aminoglycoside.

8. An optical disc, comprising:
a substrate, formed of a biodegradable material;
a reflective layer, formed over a first surface of the substrate;
a recording layer, formed over the reflective layer;
a cover layer, formed over the recording layer; and
a coating layer, formed over a second surface of the substrate, and the coating layer comprising a plurality of microcapsules containing an additive and/or mixing with the additive.

9. The optical disc of claim 8, wherein the structure of the optical disc is configured to comply with one selected from the group consisting of: a Blu-ray disc (BD) specification, a DVD+R specification, a DVD−R specification, a DVD+RW specification, a DVD−RW specification, and a High Density DVD (HD-DVD) specification.

10. The optical disc of claim 9, wherein the biodegradation material is one selected from the group consisting of: Polylactic acid (PLA), starch, Polycaprolactone (PCL), Poly vinyl alcohol (PVA), Dihydroxy acid dibastic alcohol, Aromatic hydrocarbon copolyester, and poly-3-hydroxybutyrate-co-3-polyhydroxyvalerate (PHBV).

11. The optical disc of claim 10, wherein the additive comprises one selected from the group consisting of at least one anti-oxidant, at least one antiseptic, and at least one antibiotic.

12. The optical disc of claim 11, wherein the at least one anti-oxidant comprises one selected from the group consisting of: sodium metabisulfite, sodium thiosulfate, Acetyl cystine, Butylated Hydroxy Anisole (BHA), Butyl Hydroxy Toluene, Tertiary-Butylhydroxyquinone (TBHQ), Dibutyl Hydroxy-Toluene (BHT), Butyl Hydroxy Anisole (BHA), L-Ascorbic Acid, Sodium L-Ascorbate, L-Ascorbyl Stearate, L-Ascorbyl Palmitate, Erythorbic Acid, Sodium Erythorbate, dl-α-Tocopherol, Propyl Gallate, Guaiac Resin, L-Cysteine Monohydro-chloride, Tertiary-Butyl Hydro-quinone, Calcium L-Ascorbate, Tocopherols Concentrate Mixed, d-α-Tocopherol Concentrate, EDTA Na₂ or EDTA CaNa₂, Potassium Sulfite, Sodium Sulfite, Sodium Sulfite (Anhydrous), Sodium Bisulfite, Sodium Hydrosulfite, Potassium Metabisulfite, Potassium Bisulfite, and Sodium Metabisulfite.

13. The optical disc of claim 11, wherein the at least one antiseptic comprises one selected from the group consisting of: Benzalkonium chloride, Butylene chlorohydrin, Thimerosal, Phenylmercuric acetate, Phenylmercuric nitrate, Sorbic acid, Potassium Sorbate, Sodium Sorbate, Calcium Propionate, Sodium Propionate, Dehydroacetic Acid, Benzoic Acid, Sodium Benzoate, Ethyl p-Hydroxy-benzoate, Propyl p-Hydroxy-benzoate, Butyl p-Hydroxy-benzoate, Isopropyl p-Hydroxybenzoate, Isobutyl p-Hydroxy-benzoate, Biphenyl, Sodium iacetate, Calcium Sorbate, Potassium Benzoate, Nisin, Thiamine Dilauryl-sulfate, Propionic Acid and Natamycin.

14. The optical disc of claim 11, wherein the at least one antibiotic comprises one selected from the group consisting of: Oxazolidone, iso-Oxazoline, Chitin, Nitric oxide, and Aminoglycoside.
